(19) United States
(12) Patent Application Publication
(10) Pub. No.: US 2005/0199337 A1
(43) Pub. Date: Sep. 15, 2005

(54) Single sheet joining method and apparatus using the same

(75) Inventors: Toshirou Nishikubo, Osaka (JP); Kazuo Kitada, Osaka (JP); Hiroshi Aizawa, Osaka (JP); Kazuhiro Higashio, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation

(21) Appl. No.: 11/071,243

(22) Filed: Mar. 4, 2005

(30) Foreign Application Priority Data
Mar. 15, 2004 (JP) JP2004-072627
Nov. 1, 2004 (JP) JP2004-318057

(51) Int. Cl. B32B 31/00

(52) U.S. Cl. 156/247; 156/541; 156/510

(57) ABSTRACT

A continuous band-shaped film is guided to a predetermined transport path by a guide roller while separating a protective film, and a single polarizer is supplied to a space between the guide roller and a liftable joining roller disposed above the guide roller so as to face the guide roller while separating a separator. In a state where the joining roller is lifted to create the space between the rollers, the polarizer is supplied to the space between the rollers. When the tip end of the polarizer reaches a predetermined position in the created space between the upper and lower rollers, the joining roller is lowered and the polarizer supplied synchronously with transportation of the film is pressed against the film and joined.

### BACKGROUND OF THE INVENTION

(1) Field of the Invention

The present invention relates to a single sheet joining method for use in a process of joining a sheet such as a functional film to a flexible single film in a process of manufacturing a liquid crystal display, and an apparatus using the same.

(2) Description of the Related Art

Hitherto, there is means for fabricating a laminated optical film by placing a thin single film (polarizer) obtained by being punched and cut from a material roll onto a band-shaped functional film (retardation film) by a manual work and, then, joining the films.

Concretely, polarizers are arranged and placed on a band-shaped retardation film at equal intervals at a predetermined angle, and the retardation film is fed to a space between pressing rollers fixedly disposed so as to face each other in the vertical direction to join the polarizers to the retardation film (see, for example, JP-A 10-206631 (1998)).

The conventional method, however, has the following problem.

Specifically, the polarizer is thin and is apt to deflect like the retardation film. Since a separator is attached to a joining face of the polarizer, the thin separator is separated by a manual work and, after that, the thin polarizer has to be placed on the retardation film by a manual work. There is inconvenience that the method is troublesome.

### SUMMARY OF THE INVENTION

The present invention has been achieved by paying attention to such circumstances and its main object is to provide a single sheet joining method capable of automatically efficiently performing a process of joining a single sheet which is not easily handled to a band-shaped sheet, and an apparatus using the method.

In order to achieve the above object, the present invention employs the following configuration.

A method of joining single sheets to a band-shaped sheet, comprising the step of:
using a guide roller for guiding the band-shaped sheet to a predetermined transport path and a liftable joining roller which is disposed above the guide roller so as to face the guide roller, feeding the tip end of the single sheet to a predetermined position above the guide roller in a state where the joining roller is lifted and, after that, descending the joining roller to bond the single sheet onto the sheet while pressing the single sheet.

According to this method, when the joining roller is lifted, a space is created between the joining roller and the guide roller. The single sheet is fed above the guide roller in the space, so that the tip end of the single sheet can be prevented from coming into contact with the roller until it reaches the predetermined position. In other words, the joining roller descends in a state where the single sheet is correctly introduced to the predetermined position between the rollers and presses the single sheet against the sheet to bond them.

Therefore, according to this method, the single sheet can be smoothly supplied to the space between the upper and lower rollers and adhered to the band-shaped sheet. Thus, the process of joining the thin single sheet which is apt to deflect to the sheet can be automatically, efficiently performed.

Preferably, the predetermined position above the guide roller, to which the tip end of the single sheet is fed is a position on an almost center line connecting the axis of the joining roller and the axis of the guide roller.

Generally, when the single sheet is fed to the space between the joining roller and the guide roller in a state where the tip end is a free end, the tip end of the single sheet tends to be deflected downward by dead load, particularly, in a mountain shape in which both ends in the width direction are deflected downward. According to this method, however, the space is created between the upper and lower rollers and the height at which the single sheet is supplied is preset to be high. Consequently, the tip end of the single sheet fed to the space between the upper and lower rollers is prevented from being joined to the joining face of the sheet without being correctly positioned. When the joining roller descends, the single sheet deformed in a mountain shape is pressed from above and is corrected to a posture along the joining roller, that is, a posture parallel to the sheet, and the single sheet is joined to the sheet.

Therefore, occurrence of a wrinkle in the joining face and capture of air caused by the wrinkle are prevented and the sheet can be properly joined to the single sheet.

Preferably, a separator or a protective film is joined to each of both faces of the single sheet, one of the faces serves as a face to be joined to the band-shaped sheet, and an adhesive tape is joined to the separator or protective film on the joining face and is turned backward along a knife edge, thereby feeding the single sheet to the predetermined position on the front side of the knife edge while separating the separator or protective film.

According to this method, the adhesive tape joined to the separator or protective film attached to the single sheet is turned backward along the knife edge, so that the single sheet can be fed from the knife edge with one side thereof held while separating the separator or protective film joined to the adhesive tape and inserted to the space between the upper and lower rollers.

Therefore, the single sheet can be processed in a state where the separator or protective film is attached until the single sheet is joined to the sheet. Adhesion of dusts and the like can be avoided and the quality can be improved. Moreover, handling such as transportation and storage is facilitated and it is effective for automation of the joining process.

Preferably, a separator or a protective film is joined to each of both faces of the band-shaped sheet, one of the faces serves as a joining face to which the single sheet is to be joined, and prior to joining of the sheet and the single sheet, the separator or protective film on the joining face side of the sheet is separated.

According to this method, the separator or protective film is attached also to the sheet. The sheet can be handled in a state where the separator or protective film is attached until the sheet and the single sheet are joined to each other.

Therefore, adhesion of dusts and the like to the joining face of the sheet can be avoided and the quality can be improved. Moreover, handling such as transportation and storage is facilitated and it is effective for automation of the joining process.

Preferably, an adhesive is applied on the joining face of at least one of the single sheet and the band-shaped sheet, and the single sheet and the band-shaped sheet are joined to each other via the adhesive.

According to this method, the single sheet and the band-shaped sheet can be joined to each other via an adhesive, so that floating or separation does not occur after the joining. Thus, reliable joining is realized.

Examples of the single sheet may include a film, a polarizer, and a brightness enhancement film.

In order to achieve the above object, the present invention also employs the following configuration.

An apparatus for sequentially joining single sheets at a predetermined pitch onto a band-shaped sheet, the apparatus comprising:
a guide roller for guiding the sheet to a predetermined transport path;
a liftable joining roller disposed above the guide roller so as to face the guide roller;
sheet transport means for transporting the sheet; and
single sheet supply means for feeding the single sheet to a predetermined joining position above the guide roller; and
roller lift means for lifting and lowering the joining roller on the basis of positioning of the single sheet fed to the predetermined joining position.

In this apparatus, the guide roller guides the sheet to a predetermined transport path. The joining roller is disposed so as to face the guide roller and is liftable by the roller lift means. The sheet transport means transports the sheet to the predetermined position where the single sheet is joined. The single sheet supply means feeds the single sheet to a predetermined joining position. Specifically, in a state where the joining roller is positioned above the guide roller and facing the guide roller by the roller lift means, the tip end of the single sheet is fed above the guide roller in the space between the joining roller and the guide roller. When the tip end of the single sheet reaches a predetermined position, the joining roller is lowered to bond the single sheet to the sheet. That is, the single sheet joining method can be suitably realized.

Preferably, this apparatus further comprises cutting means for cutting the sheet to which the single sheet is joined along the outer shape of the single sheet synchronously with a pause timing of the feeding of the single sheet at a predetermined pitch. With this configuration, single sheets can be contained and handled individually or in predetermined number.

The single sheet is effective to use a member which is apt to deflect such as a film, a polarizer, or a brightness enhancement film.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a side view showing a schematic general configuration of a single sheet joining apparatus;

FIG. 2 is a side view of a main portion showing a single sheet joining process;

FIG. 3 is a side view of the main portion showing the single sheet joining process;

FIG. 4 is a side view of the main portion showing the single sheet joining process;

FIGS. 5A and 5B are front views of a main portion at the start of joining a single sheet;

FIG. 6 is a side view of a main portion showing a joining process of an apparatus of a modification;

FIG. 7 is a side view of the main portion showing the joining process of the apparatus of the modification; and

FIG. 8 is a side view of the main portion showing the joining process of the apparatus of the modification.

### DESCRIPTION OF THE PREFERRED EMBODIMENTS

An embodiment of the present invention will be described below with reference to the drawings.

A single sheet of the present invention is not particularly limited as long as it is a flexible film such as a polarizer, a retardation film, or a brightness enhancement film. In this embodiment, the case of using a polarizer will be described. A band-shaped sheet of the present invention is not particularly limited as long as it is a band-shaped functional film such as a polarizer, a retardation film, or a brightness enhancement film. In this embodiment, the case of using a retardation film will be described.

Each of a separator and a protective film of the present invention is used for coverage and protection in order to prevent the surface from being damaged. The separator is separated and removed at an adhesion interface with an adhesive applied on a single sheet or a band-shaped sheet. On the other hand, the protective film is separated and removed together with an adhesive by a film to which the adhesive is applied.

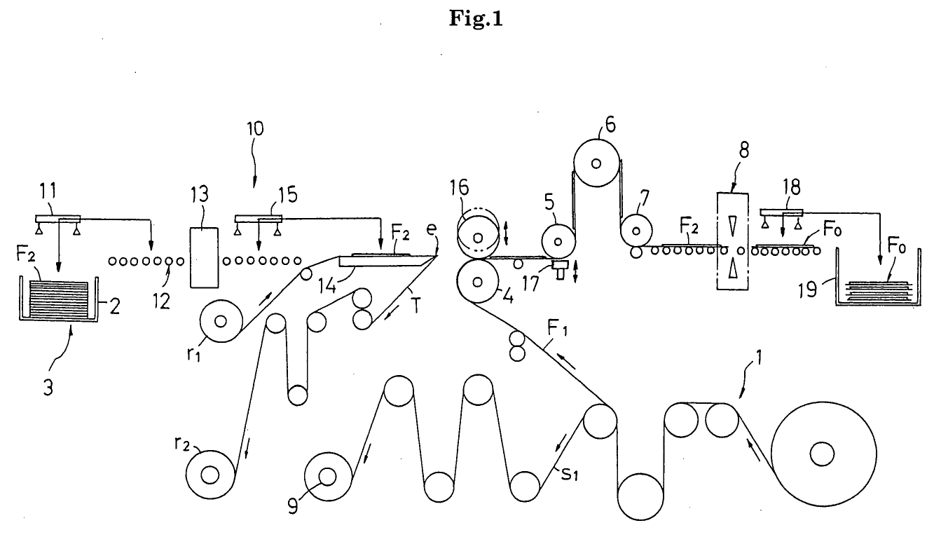

FIG. 1 shows a schematic configuration of a single sheet joining apparatus for executing the single sheet joining method of the present invention.

A film F₁ as a retardation film is loaded in a roll state obtained by forming slits at predetermined intervals in a wide material roll to a film supply unit 1. Polarizers F₂ as single sheets obtained by punching out in a predetermined dimension from a wide substrate are stacked in a supply magazine 2 and are loaded to a polarizer supply unit 3. A separator is adhered via an adhesive to one of the faces of each of the film F₁ and the polarizer F₂, and a protective film is adhered to the other face. The film F₁ is loaded to the film supply unit 1 so that the face to which a protective film s₁ is adhered is used as a joining face. The polarizers F₂ are stacked in the supply magazine 2 with the face to which a separator s₂ is adhered facing downward.

The film F₁ loaded in a roll state in the film supply unit 1 is guided by a group of guide rollers to a guide roller 4 in a joining position. After that, the film F₁ is transported along a transport path formed by a guide roller 5, a dancer roller 6, a brake roller 7 and the like and fed to a cutting processing unit 8. The rollers including the group of guide rollers, the guide roller 5, the dancer roller 6, and the brake roller 7 construct sheet transport means of the present invention.

The protective film s₁ is attached to the joining face of the film F₁. The protective film s₁ is separated at some midpoint in a film supply path to the guide roller 4 and collected by a collecting roller 9. The film F₁ is guided to the guide roller 4 with its joining face facing upward.

Above the polarizer supply unit 3, a vacuum suction-type pickup device 11 which is movable in the vertical and horizontal directions is disposed. The pickup device 11 picks up the polarizers F₂ stacked in the supply magazine 2 one by one from the top by suction.

The pickup device 11 suction-holding the polarizer F₂ is lifted and moved forward to transfer the polarizer F₂ to a polarizer supplying apparatus 10 disposed between the joining position and the polarizer supply unit 3. In association with pickup of the polarizer F₂, the supply magazine 2 is lifted.

The polarizer supplying apparatus 10 includes a roller conveyer 12, a cleaning mechanism 13, a supply plate 14, and a vacuum suction-type pickup device 15. Specifically, the polarizer F₂ picked up from the supply magazine 2 by the pickup device 11 is transferred to the roller conveyer 12 and transported horizontally. During transportation, the polarizer F₂ is subjected to a cleaning process by the cleaning mechanism 13 and, after that, transferred onto the supply plate 14 by the pickup device 15. The supply plate 14, and a pressing roller 20, a suction mechanism 21, a cylinder 22, and a knife edge “e” which will be described later construct single sheet supply means of the present invention.

An adhesive tape T for separating a separator, which is fed out from a feed roll r₁ is guided and supplied with its adhesion face facing upward onto the top face of the supply plate 14, and the polarizer F₂ is placed on the top face of the adhesive tape T, thereby joining the separator s₂ attached on the under face of the polarizer F₂ to the adhesive tape T.

In a state where the polarizer F₂ is placed on the supply plate 14, the suction mechanism 21 disposed in a quadrate opening formed in the center of the supply plate 14 so as to be slidable in the travel directions of the adhesive tape T vacuum-sucks the polarizer F₂ integrated with the adhesive tape T and supports the polarizer F₂ so that the polarizer F₂ is closely attached to the top face of the supply plate 14 by a proper suction force. At almost the same time, the pressing roller 20 descends from a position above the tip end in the travel direction of the polarizer F₂ and presses the tip end of the polarizer F₂ with the knife edge “e” at the tip end of the supply plate 14.

After that, in synchronization with sliding movement in a predetermined stroke by expansion/contraction of the cylinder 22 linked to the bottom of the suction mechanism 21 and take-up of the adhesive tape T by a take-up roll r₂, the polarizer F₂ is fed forward together with the adhesive tape T along the top face of the supply plate 14. The adhesive tape T is turned backward along the knife edge “e” formed at the tip end of the supply plate 14, the separator s₂ joined to the adhesive tape T is turned integrally with the adhesive tape T and is separated from the under face to which the adhesive is adhered of the polarizer F₂. After the separator s₂ is separated and removed, only the polarizer F₂ on which the adhesive is exposed is fed forward of the knife edge “e”.

By the forward movement of the predetermined stroke of the suction mechanism 21, the polarizer F₂ extended from the tip end of the knife edge “e” can be fed to the joining position. In this case, it is set so that the level of the top face of the supply plate 14 becomes higher than the upper end of the guide roller 4 only by a proper dimension. The stroke of the cylinder 22 for making the suction mechanism 21 slide for feeding the polarizer F₂ to the joining position and the level of the top face of the supply plate 14 are properly set in accordance with the dimensions (including thickness), shape, material, and the like of the polarizer F₂.

The guide roller 4 for guiding the film F₁ in the joining position takes the form of a rubber roller which is driven by a motor. Immediately above the guide roller 4, a joining roller 16 taking the form of a metal roller driven by a motor is disposed so as to be movable in the vertical direction. When the supply plate 14 moves forward to feed the polarizer F₂ to the joining position, the joining roller 16 is lifted to a position higher than the top face of the supply plate 14 to create a space between the rollers. Each of the guide roller 4 and the joining roller 16 may be a rubber roller or a metal roller.

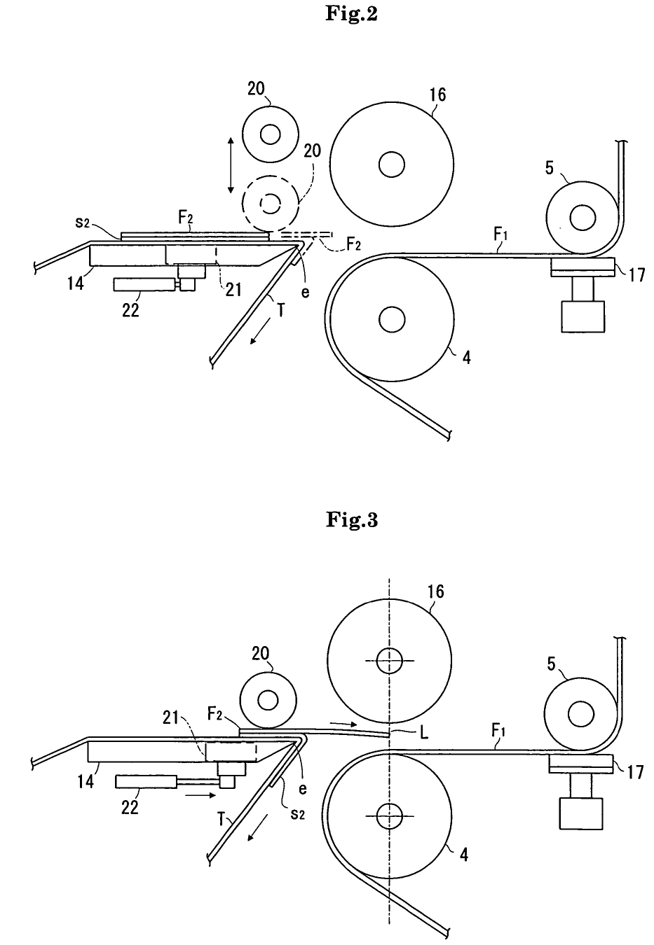

The configurations and functions of the main portion of the single sheet joining apparatus according to the present invention are described above. The procedure of joining single sheets by using the apparatus will be described with reference to FIGS. 2 to 4.

(1) As shown in FIG. 2, the polarizer F₂ is supplied onto the supply plate 14 in which the suction mechanism 21 is in a receded position, and is placed on the top face of the adhesive tape T. At this time, the suction mechanism 21 provided for the supply plate 14 vacuum-sucks the polarizer F₂ integrated with the adhesive tape T. The suction mechanism 21 supports the polarizer F₂ to be closely attached to the top face of the supply plate 14 by a proper suction force and, almost simultaneously, the pressing roller 20 descends to press the tip end of the polarizer F₂.

(2) Next, forward sliding of the suction mechanism 21 provided for the supply plate 14 and take-up of the adhesive tape T are performed synchronously, so that the polarizer F₂ moves forward along the top face of the supply plate 14 integrally with the adhesive tape T. The adhesive tape T is turned backward along the knife edge “e”, so that the separator s₂ joined to the adhesive tape T is separated from the under face of the polarizer F₂. Simultaneously, as shown by an imaginary line in FIG. 2, the polarizer F₂ itself is fed forward from the tip end of the knife edge “e”.

(3) As shown in FIG. 3, the tip end of the polarizer F₂ is fed to a space between the guide roller 4 and the joining roller 16 in the joining position. Since the joining roller 16 recedes upward, a space is created between the rollers, and the supply plate 14 is set to a position higher than the guide roller 4, the polarizer F₂ is supplied so as to be inserted to the large space between the upper and lower rollers without coming into contact with the film F₁.

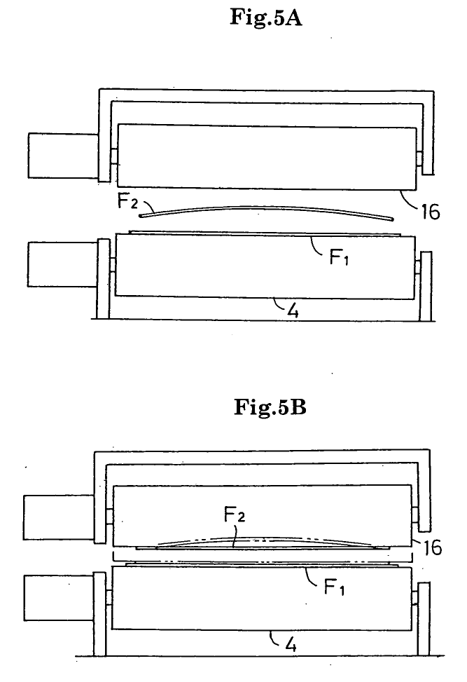

(4) As shown in FIG. 3, when the suction mechanism 21 reaches the terminating end of the supply plate 14 by a predetermined stroke of the cylinder 22, the tip end of the polarizer F₂ reaches an almost center line L connecting the axis of the guide roller 4 and the axis of the joining roller 16, the joining roller 16 is lowered to a predetermined joining height, and the tip end of the polarizer F₂ is pressed against the film F₁ and joined. In this case, as shown in FIG. 5A, the polarizer F₂ extended from the tip end of the knife edge “e” tends to be deflected, for example, in a mountain shape by dead load, residual stress accumulated at the time of joining of the separator s₂, and separation stress of the separator s₂. However, as shown in FIG. 5B, the polarizer F₂ is pressed by the descended joining roller 16 and, while being corrected to be horizontal, parallelly pressed against the top face of the film F₁.

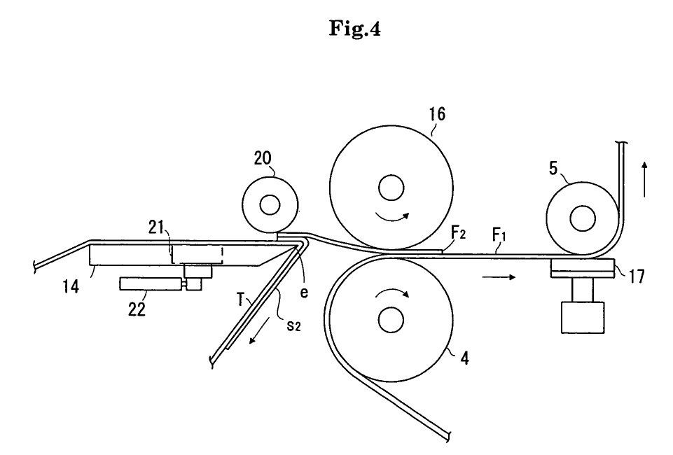

(5) After that, as shown in FIG. 4, in association with transportation of the film F₁ and take-up movement of the adhesive tape T synchronized with the transportation, the polarizers F₂ are sequentially supplied to the space between the guide roller 4 and the joining roller 16 and joined to the top face of the film F₁.

(6) When a rotary encoder, an optical sensor, or the like for detecting a predetermined rotation amount of the joining roller 16 and/or the guide roller 4 detects that the rear end of the polarizer F₂ passes through the space between the upper and lower rollers and reaches a predetermined position, the transportation of the film F₁ and the take-up of the adhesive tape T are stopped, the joining roller 16 recedes upward, and the suction mechanism 21 recedes to the original position to prepare for supply of the following polarizer F₂, thereby finishing a single joining operation. Synchronously with the upward receding of the joining roller 16, a press member 17 rises and the film F₁ is sandwiched by the guide roller 5 and the press member 17 to check backward displacement of the film F₁.

(7) By sequentially performing the joining process, the single polarizers F₂ are joined at predetermined pitches to the continuous band-shaped film F₁. The film F₁ is mechanically cut or cut with a laser synchronously with pause timings of pitch feeding by the cutting processing unit 8 disposed in a rear portion of the film transport path, and a single polarizer F₀ which is the joined polarizer F₂ is carried out by a vacuum suction-type pickup device 18 and stacked and collected in a collection magazine 19.

In the cutting processing unit 8, two optical sensors for detecting the tip end of the polarizer F₂ and a movement distance of the tip end are disposed on a straight line in the travel direction to determine the cutting position of the polarizer F₂. At the time of cutting, each of the front side of the polarizer F₂ and the rear side of a cut portion is clamped by a clamp, the front and rear sides are slid while changing movement amounts, and the cut portion of the adhesive tape T is tensioned.

As described above, the joining roller 16 is lifted to assure the space from the guide roller 4, the thin polarizer F₂ is fed to the joining position between the rollers while preventing the tip end of the thin polarizer F₂ which is apt to deflect from coming into contact with the guide roller 4, and the deflected polarizer F₂ is pressed against the guide roller 4 while being corrected with descending of the joining roller 16. Therefore, the polarizer F₂ which is a thin sheet and/or a film and the film F₁ can be automatically joined to each other and occurrence of a wrinkle at the time of joining and capture of air accompanying the occurrence of a wrinkle can be avoided.

Since the polarizer F₂ can be handled in a state where the face to be joined to the film F₁ of the polarizer F₂ faces downward and the separator s₂ of the polarizer F₂ is not separated by the time the film F₁ is joined, adhesion of dusts and the like to the face to which the film F₁ is to be joined of he polarizer F₂ can be avoided. Similarly, the protective film s₁ remains joined to the film F₁ by the time of joining, so that adhesion of dusts and the like to the joining face can be avoided. Therefore, the quality can be improved.

The present invention is not limited to the foregoing embodiment but can be also modified as follows.

(1) Although the film F₁ is joined to the thin single polarizer F₂ in the foregoing embodiment, a single film such as a retardation film or a brightness enhancement film can be joined in place of the polarizer F₂ to the film F₁. In place of the film F₁, a band-shaped functional film such as a polarizer or a brightness enhancement film or a flexible sheet member thicker than the film may be also employed.

(2) Although the separator s₂ is separated from the single sheet F₂ and the protective film s₁ is separated from the film F₁ in the foregoing embodiment, the following form may be also employed. For example, the single sheets F₂ are contained upside down in the supply magazine 2, the protective film on the opposite face is separated in place of the separator s₂, the film F₁ is loaded so that the face to which the separator is joined is used as a joining face to the film supply unit 1, the separator on the opposite face is separated in place of the protective film s₁, and the single sheet F₂ and the film F₁ are joined to each other.

(3) Although the single sheet F₂ and the film F₁ each having one face to which the separator is joined and the other face to which the protective film is joined are used in the foregoing embodiment, a polarizer and a film to each of which separators or protective films are joined on both faces may be also employed.

(4) The polarizer F₂ is fed to the joining position by sliding the suction mechanism 21 provided for the supply plate 14 only by a predetermined stroke via the cylinder 22 in the foregoing embodiment. Alternatively, the following configuration may be employed.

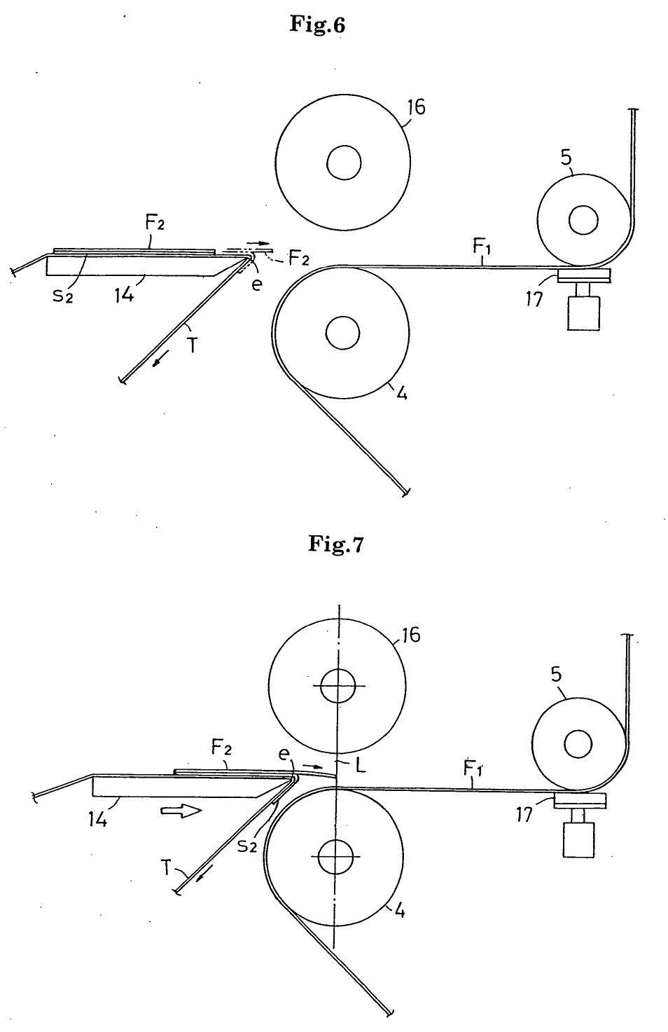

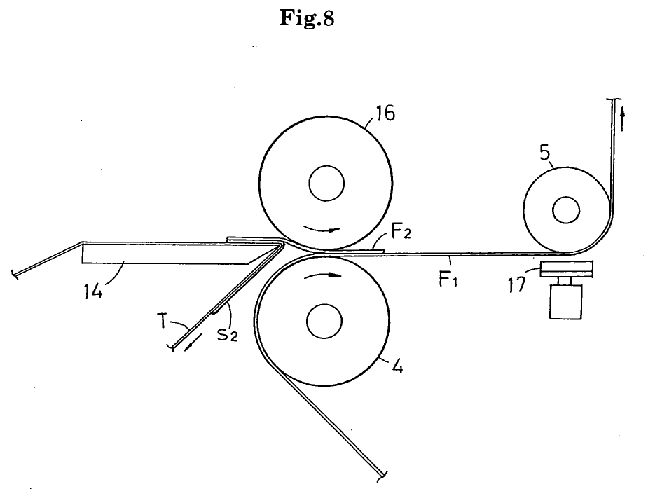

For example, as shown in FIGS. 6 to 8, the adhesive tape T and the polarizer F₂ are suction-held on the supply plate 14. While the supply plate 14 itself is slid forward by a predetermined stroke via a driving mechanism such as a cylinder or a drive motor, the separator s₂ is separated from the polarizer F₂ only by the knife edge “e” without pressing the polarizer F₂ with the pressing roller 20, and the polarizer F₂ is fed. With such a configuration, exposure time of the joining face of the polarizer F₂ can be shortened and it is effective to avoid adhesion of dusts and the like.

The predetermined stroke of sliding the supply plate 14 is preset by using an operation panel of an apparatus (not shown) in accordance with the dimensions, shape, and the like of the polarizer F₂.

The present invention may be embodied in other specific forms without departing from the spirit or essential attributes thereof and, accordingly, reference should be made to the appended claims, rather than to the foregoing specification, as indicating the scope of the invention.

1. A method of joining single sheets to a band-shaped sheet, comprising the step of:
using a guide roller for guiding the band-shaped sheet to a predetermined transport path and a liftable joining roller which is disposed above the guide roller so as to face the guide roller, feeding the tip end of the single sheet to a predetermined position above the guide roller in a state where the joining roller is lifted and, after that, descending the joining roller to bond the single sheet onto the sheet while pressing the single sheet.

2. The method according to claim 1, wherein
the predetermined position above the guide roller, to which the tip end of the single sheet is fed is a position on an almost center line connecting the axis of the joining roller and the axis of the guide roller.

3. The method according to claim 1, wherein
a separator or a protective film is joined to each of both faces of the single sheet, one of the faces serves as a face to be joined to the band-shaped sheet, and
an adhesive tape is joined to the separator or protective film on the joining face and is turned backward along a knife edge, thereby feeding the single sheet to the predetermined position on the front side of the knife edge while separating the separator or protective film.

4. The method according to claim 1, wherein
a separator or a protective film is joined to each of both faces of the band-shaped sheet, one of the faces serves as a joining face to which the single sheet is to be joined, and
prior to joining of the sheet and the single sheet, the separator or protective film on the joining face side of the sheet is separated.

5. The method according to claim 1, wherein
an adhesive is applied on the joining face of at least one of the single sheet and the band-shaped sheet, and the single sheet and the band-shaped sheet are joined to each other via the adhesive.

6. The method according to claim 1, wherein
the sheet member is a film.

7. The method according to claim 1, wherein
the sheet member is a polarizer.

8. The method according to claim 1, wherein
the single sheet is a brightness enhancement film.

9. An apparatus for sequentially joining single sheets at a predetermined pitch onto a band-shaped sheet, the apparatus comprising:
a guide roller for guiding the sheet to a predetermined transport path;
a liftable joining roller disposed above the guide roller so as to face the guide roller;
sheet transport means for transporting the sheet; and
single sheet supply means for feeding the single sheet to a predetermined joining position above the guide roller; and
roller lift means for lifting and lowering the joining roller on the basis of positioning of the single sheet fed to the predetermined joining position.

10. The apparatus according to claim 9, further comprising:
cutting means for cutting the sheet to which the single sheet is joined along the outer shape of the single sheet synchronously with a pause timing of the feeding of the single sheet at a predetermined pitch.

11. The apparatus according to claim 9, wherein
the single sheet is a film.

12. The apparatus according to claim 9, wherein
the single sheet is a polarizer.

13. The apparatus according to claim 9, wherein
the single sheet is a brightness enhancement film.
